(19) United States
(12) Patent Application Publication
(10) Pub. No.: US 2025/0229387 A1
(43) Pub. Date: Jul. 17, 2025

(54) Ratchet Tool Including Pawl with Biasing Effect

(71) Applicant: Harbor Freight Tools USA, Inc., Calabasas, CA (US)

(72) Inventor: Oaty Anthony Frye, JR., Middleton, CT (US)

(21) Appl. No.: 18/413,936

(22) Filed: Jan. 16, 2024

(51) Int. Cl. B25B 13/46

(52) U.S. Cl. CPC B25B 13/463; B25B 13/467

(57) ABSTRACT

A ratchet tool that permits a user to selectively determine the direction in which torque is applied to a work piece is disclosed. A rear surface of a pawl creates an instability between a biasing member and the rear surface when the biasing member engages the rear surface at the mid-plane of the pawl. The instability leads to a net force that directs the biasing member and the pawl away from the mid-plane. This arrangement ensures that pawl does not position itself in a central resting position between the sidewalls of a ratchet head.

### BACKGROUND

The present disclosure relates generally to a pawl for use in a ratchet tool. Ratchet tools include for example ratchet wrenches and torque wrenches. Such ratchet tools typically include a reversible drive, which is capable of applying torque to a work piece in both a first rotational direction or a second rotational direction to tighten or loosen fasteners.

Ratchet tools generally include a cylindrical gear attached to the drive, a pawl to engage the gear, a switch to control the relative orientation of the pawl with respect to the gear, and a biasing member disposed within the switch. Typically, the biasing member engages with a rear surface of the pawl to bias the pawl towards the gear. The application of torque to a fastener relies on the mechanical engagement of the pawl and the gear preventing rotation of the gear (and in turn the drive) in either the first or the second rotational direction.

Traditional ratchet tools include a pawl with a symmetrical rear surface. In these traditional pawl configurations, when the biasing member contacts the symmetrical rear surface of the pawl at a mid-plane of the pawl, the pawl may undesirably position itself in a central resting position at the mid-plane of the ratchet gear, between the sidewalls of a ratchet assembly cavity. Such a position may be prone to gear slippage or failure. In this central resting position, a net zero force is generated by the symmetrical rear surface of the pawl and a biasing force of the biasing member when the biasing member contacts the pawl at the mid-plane. It is therefore advantageous to eliminate the possibility of the central resting position and ensure the pawl is fully biased in either the clock-wise or counter-clockwise position to improve the reliability of a ratchet tool. It is further advantageous to provide a pawl operable to generate a net force that directs the pawl away from the mid-plane when the biasing member contacts the pawl at the mid-plane.

### SUMMARY

A ratchet tool including a pawl with biasing effect is disclosed, as illustrated by and described in connection with the figures of the present disclosure, and as set forth in the claims.

Specifically, disclosed is an example ratchet tool. The ratchet tool includes a ratchet head include a ratchet assembly cavity and a ratchet gear rotatably disposed in the ratchet assembly cavity. The ratchet gear includes a drive member for transmitting torque to a work piece. The ratchet gear also defines a perimeter and a plurality of ratchet gear teeth disposed about the perimeter. The ratchet tool further includes a pawl operable to selectively engage with the ratchet gear. The pawl includes a front surface defining a front surface midpoint and a first plurality of pawl teeth disposed on a first side of the front surface midpoint. The first plurality of pawl teeth are selectively engageable with the ratchet gear teeth. The front surface further defines a second plurality of pawl teeth disposed on a second side of the front surface midpoint. The second plurality of pawl teeth are selectively engageable with the ratchet gear teeth. The pawl is operable to selectively engage either of the first and second pluralities of pawl teeth with the ratchet gear teeth to limit rotation of the ratchet gear in one of a first rotational direction and a second rotational direction. The pawl further includes a rear surface defining a rear surface midpoint and a mid-plane intersecting the front surface midpoint and the rear surface midpoint. The rear surface further defines an engagement surface disposed in an engagement plane. The engagement plane is disposed at a selected angle with respect to the mid-plane of the pawl. The ratchet tool further includes a switch disposed through a switch aperture in the ratchet assembly cavity. The switch includes a biasing member operable to engage the rear surface of the pawl such that the biasing member urges the pawl against the ratchet gear.

In one example, the selected angle of the engagement surface is non-perpendicular. In another example, the engagement surface is sloped relative to the mid-plane of the pawl. In another example, the engagement surface creates an instability between the biasing member and the pawl at the mid-plane of the pawl and a mid-plane of the ratchet gear such that the pawl is forced in either the first rotational direction or the second rotational direction.

In one example, the engagement surface of the pawl includes a first concave curve, a second concave curve, and a convex curve formed between the first concave curve and the second concave curve. In one example, the convex curve is positioned off-center to the mid-plane of the pawl and a tangent of the convex curve forms a non-perpendicular angle relative to the mid-plane of the pawl. In another example, the convex curve creates an instability between the biasing member of the pawl at the mid-plane of the pawl and a mid-plane of the ratchet gear such that the pawl is forced in either a first rotational direction or the second rotational direction.

In one example, the biasing member includes a spring and a pin. The spring and the pin are at least partially disposed within the switch. In one example, the pin includes a body and a head. In this example, the head includes a non-planar surface.

Also disclosed is an example ratchet tool. The ratchet tool includes a ratchet head. The ratchet head includes a ratchet assembly cavity and a ratchet gear rotatably disposed in the ratchet assembly cavity. The ratchet gear includes a drive member for transmitting torque to a workpiece. The ratchet gear defines a perimeter and a plurality of gear teeth disposed about the perimeter. The ratchet head further includes a pawl operable to selectively engage with the ratchet gear. The pawl includes a front surface defining a front surface midpoint including a first plurality of pawl teeth disposed on a first side of the front surface midpoint. The first plurality of pawl teeth are selectively engageable with the ratchet gear teeth. The front surface further includes a second plurality of pawl teeth disposed on a second side of the front surface midpoint. The second plurality of pawl teeth are selectively engageable with the ratchet gear teeth. The pawl is operable to selectively engage either of the first and second pluralities of pawl teeth with the ratchet gear teeth to limit rotation of the ratchet gear in one of a first rotational direction and a second rotational direction. The pawl further includes a rear surface defining a rear surface midpoint. The pawl defines a mid-plane intersecting the front surface midpoint and the rear surface midpoint. The rear surface further defines an engagement surface disposed in an engagement plane. The ratchet head further includes a switch disposed through a switch aperture in the ratchet assembly cavity and a biasing member partially disposed within the switch. The biasing member is operable to engage the engagement surface of the pawl such that the biasing member urges the pawl against the ratchet gear. A central axis of the member and the engagement surface of the pawl form a non-perpendicular surface angle when the biasing member contacts the engagement surface of the pawl.

In another example, the engagement surface is sloped relative to the mid-plane of the pawl. In another example, the engagement surface creates an instability between the biasing member and the pawl at the mid-plane of the pawl and a mid-plane of the ratchet gear such that the pawl is forced in either the first rotational direction or the second rotational direction.

In one example, the engagement surface of the pawl includes a first concave curve, a second concave curve, and a convex curve formed between the first concave curve and the second concave curve. In one example, the convex curve is positioned off-center to the mid-plane of the pawl and a tangent of the convex curve forms a non-perpendicular angle relative to the mid-plane of the pawl. In another example, the convex curve creates an instability between the biasing member of the pawl at the mid-plane of the pawl and a mid-plane of the ratchet gear such that the pawl is forced in either a first rotational direction or the second rotational direction.

Also disclosed is an example pawl for a ratchet tool. The pawl includes a front surface defining a front surface midpoint including a first plurality of pawl teeth disposed on a first side of the front surface midpoint. The first plurality of pawl teeth are selectively engageable with a plurality of ratchet gear teeth. The pawl further defines a second plurality of pawl teeth disposed on a second side of the front surface midpoint. The second plurality of pawl teeth are selectively engagement with the ratchet gear teeth. The pawl is operable to selectively engage either of the first and second pluralities of pawl teeth with the ratchet gear teeth. The pawl further includes a rear surface defining a rear surface midpoint. The pawl further defines a mid-plane intersecting the front surface midpoint and the rear surface midpoint. The rear surface further defines an engagement surface disposed in an engagement plane, the engagement plane disposed at a selected angel with respect to the mid-plane. The engagement surface creates an instability between a biasing member and the pawl when the biasing member contacts the pawl at the mid-plane of the pawl such that the pawl is forced in either a first rotational direction or a second rotational direction.

In one example, the selected angle of the engagement surface is non-perpendicular. In another example, the engagement surface is sloped relative to the mid-plane of the pawl.

In one example, the engagement surface of the pawl includes a first concave curve, a second concave curve, and convex curve formed between the first concave curve and the second concave curve. In another example, the convex curve is positioned off-center to the mid-plane of the pawl and a tangent of the convex curve forms a non-perpendicular angle relative to the mid-plane of the pawl.

### BRIEF DESCRIPTION OF SEVERAL VIEWS OF DRAWINGS

The following is a brief description of the drawings pertaining to the present disclosure, which will be discussed in more detail in the detailed description section below:

FIG. 1 illustrates an exploded perspective view of a ratchet head of a ratchet tool.

FIG. 2 illustrates a top perspective view of a front side of the ratchet head, showing a ratchet assembly positioned within a ratchet assembly cavity in a first position (clockwise position).

FIG. 3 illustrates a perspective view of a pawl showing a front surface of the pawl.

FIG. 4 illustrates a top plan view of the pawl showing reference to FIG. 6 according to one aspect of the present disclosure.

FIG. 5 illustrates a bottom-rear perspective view of the pawl showing a rear surface of the pawl.

FIG. 6 illustrates a top plan view of the pawl, showing an engagement surface of the pawl.

FIG. 7 illustrates a top plan view of the ratchet assembly in the first position (clockwise position) showing reference to FIG. 8.

FIG. 8 illustrates a top plan view of a biasing member and the pawl, showing the relative forces of the biasing member and the pawl in the first position (clockwise position).

FIG. 9 illustrates a top plan view of the ratchet assembly in a temporary position showing reference to FIG. 10.

FIG. 10 illustrates a top plan view of the biasing member and the pawl, showing the relative forces of the biasing member and the pawl in the temporary position.

FIG. 11 illustrates a top plan view of the ratchet assembly in a second position (counter-clockwise position) showing reference to FIG. 12.

FIG. 12 illustrates a top plan view of a biasing member and the pawl, showing the relative forces of the biasing member and the pawl in the second position (counter-clockwise position).

FIG. 13 illustrates a top plan view of an alternative configuration of the pawl.

FIG. 14 illustrates a detail top plan view of the portion of the pawl identified in FIG. 13, showing an engagement surface of the pawl.

FIG. 15 illustrates a top plan view of the biasing member and the pawl of FIG. 13, showing the relative forces of the biasing member and the pawl in the temporary position.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

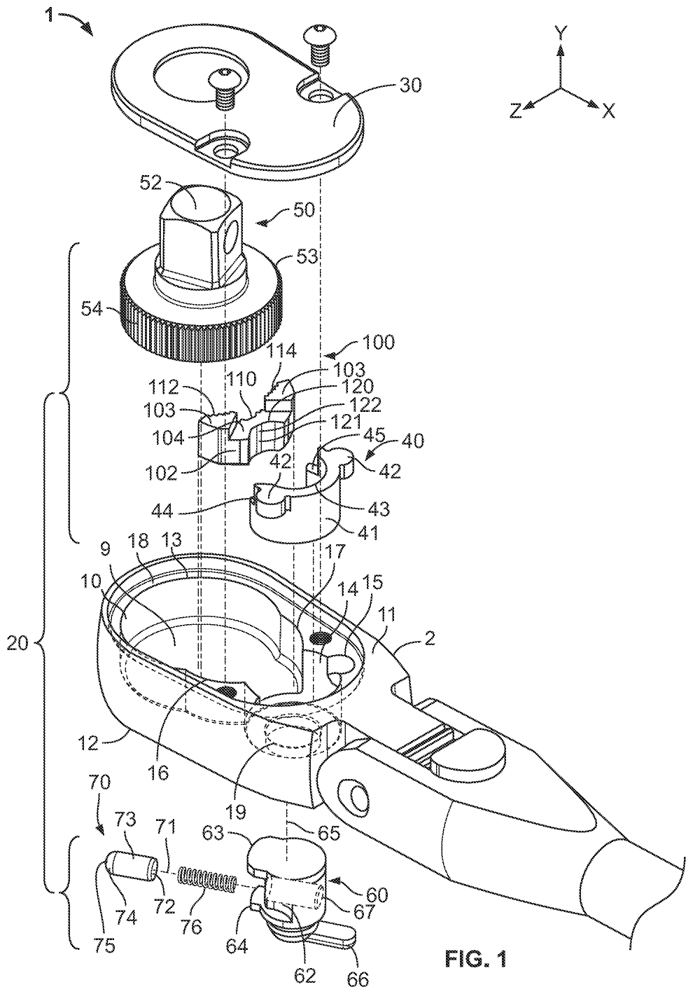

The present disclosure relates to a ratchet tool that enables a user to selectively determine the direction (i.e., clockwise or counter-clockwise) in which torque is applied to a work piece (not shown). Amongst other factors, a reliable ratchet tool requires stabile yet dynamic engagement of the tool's internal and/or external components. A ratchet tool 1 is shown in the exploded view of FIG. 1. Also shown in FIG. 1 are x, y, and z axes to assist in the description of the various movements and relationships of the internal components of the ratchet tool 1. As illustrated, the ratchet tool 1 of the present disclosure comprises a ratchet assembly 20 that includes a sleeve 40, a ratchet gear 50, a switch 60, a biasing member 70, and a pawl 100. The ratchet assembly 20 is disposed in a ratchet assembly cavity 13 of a ratchet head 2. The ratchet assembly cavity 13 includes a bottom surface 9, a gear sidewall 10, a first sidewall 16, a second sidewall 17, and a switch-sleeve cavity 14 operable to receive the switch 60 and the sleeve 40. Gear sidewall 10 extends from the first sidewall 16 and second sidewall 17 forming an arcuate shape that is substantially complementary to the shape of the ratchet gear 50. As shown in FIG. 1, gear sidewall 10 is positioned adjacent first sidewall 16 and second sidewall 17 and is operable to receive at least a portion of the ratchet gear 50. First sidewall 16 and second sidewall 17 each define a curved surface that is substantially complementary to the shape of the pawl 100 and are operable to receive at least a portion of the pawl 100. When assembled, ratchet gear 50 and pawl 100 contact the bottom surface 9 of the ratchet assembly cavity 13. At least a portion of pawl 100 is positioned between the first sidewall 16 and second sidewall 17 and at least a portion of the ratchet gear 50 is positioned within gear sidewall 10. As shown, the ratchet tool 1 further includes a cover plate 30 disposed in a cover plate cavity 18, operable to retain the ratchet assembly 20 within the ratchet assembly cavity 13. It is to be understood that the present disclosure contemplates a ratchet tool.

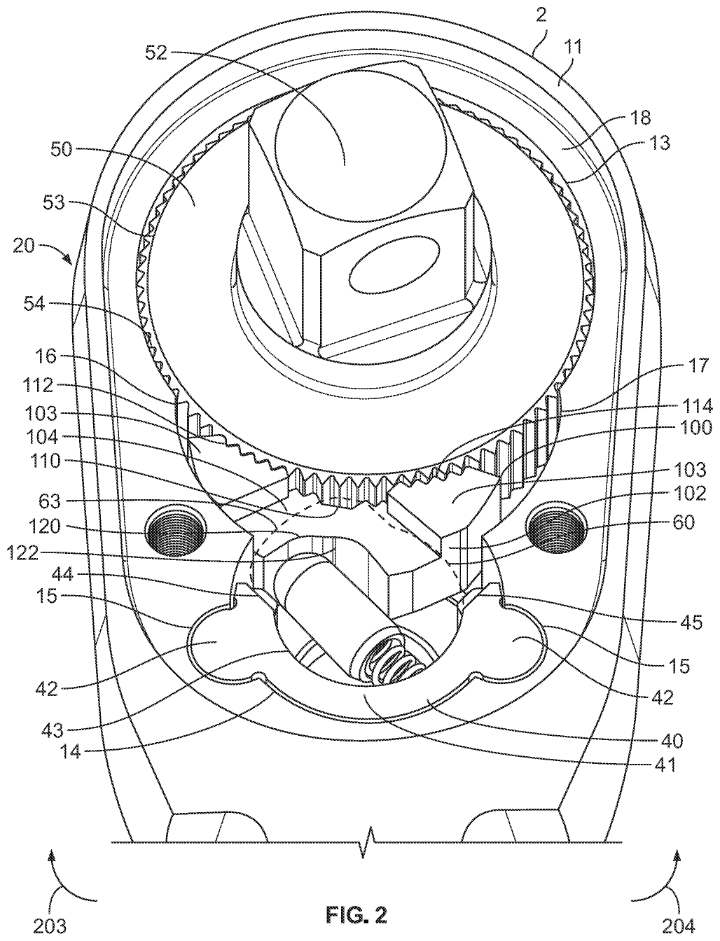

The sleeve 40 includes a body 41 that has at least a partially circumferential shape and at least partially surrounds the switch 60 (as shown in FIG. 2.). The sleeve 40 further includes at least one anchor 42 operable to engage with at least one anchor pocket 15 disposed in the switch-sleeve cavity 14 such that the sleeve 40 stabilizes the switch 60 within the ratchet head 2, and specifically, within the switch sleeve cavity 14. The sleeve 40 further includes a first portion 44 and a second portion 45 disposed on opposite ends of the body 41 operable to limit rotation of the switch 60 in a clockwise or counter-clockwise direction along the y-axis. It is to be understood that the present disclosure contemplates a ratchet tool 1 that does not include the sleeve 40.

As shown in FIGS. 1 and 2, the ratchet gear 50 is rotatably disposed in the ratchet assembly cavity 13 and includes a drive member 52 for transmitting torque to a work piece (not shown). The ratchet gear 50 defines a perimeter 53 and a plurality of gear teeth 54 disposed about the perimeter 53 to selectively engage with the pawl 100. The drive member 52 is operable to engage with a socket, fastener, or other tool. As shown, the drive member 52 has a substantially square shape, but may also have a rectangular or other shape. The drive member 52 may optionally include a ball detent operable to engage with a conventional socket.

As shown in FIGS. 1 and 2, the switch 60 is rotatably disposed through a switch aperture 19 and positioned adjacent to a switch pocket 43 of the sleeve 40. The switch 60 includes a switch body 62 and a first ledge 63 that extends away, or laterally, from a central z-axis 65 of the switch body 62. The switch 60 further includes a second ledge 64 that extends away, or laterally, from the central z-axis 65 of the switch body 62. A portion of the pawl 100 is received between the first ledge 63 and the second ledge 64, thereby limiting movement of the pawl 100 along the y-axis when the switch 60 is rotated clockwise or counter-clockwise. As shown in FIG. 1, the first ledge 63 is positioned on one side of the biasing member 70 and the second ledge 64 is positioned on the opposite side of the biasing member 70 from which where the first ledge 63 is positioned.

A user may activate the switch 60 via a switch lever 66 positioned on a rear side 12 of the ratchet head 2, opposite a front side 11 of the ratchet head 2. The user may rotate the switch 60, via the lever 66, either clockwise or counter-clockwise along the y-axis to move the pawl 100 to engage with the ratchet gear 50. In the illustrated embodiment, the switch 60 defines a bore 67 configured to partially receive the biasing member 70 that includes a pin 72. The pin 72 includes a body 73 and a head 74, wherein the head 74 includes a non-planar surface 75 operable to contact the pawl 100. The biasing member 70 further includes a central axis 71 that intersects a midpoint of the non-planar surface 75 of the pin 72. As shown in FIG. 1, the biasing member 70 also includes a spring 76. The biasing member 70 uses elastic potential energy, i.e., a biasing force generated by the compression of the spring 76, to push the pin 72 into engagement with a rear surface 120 of the pawl 100, thereby pushing the pawl 100 against the ratchet gear 50.

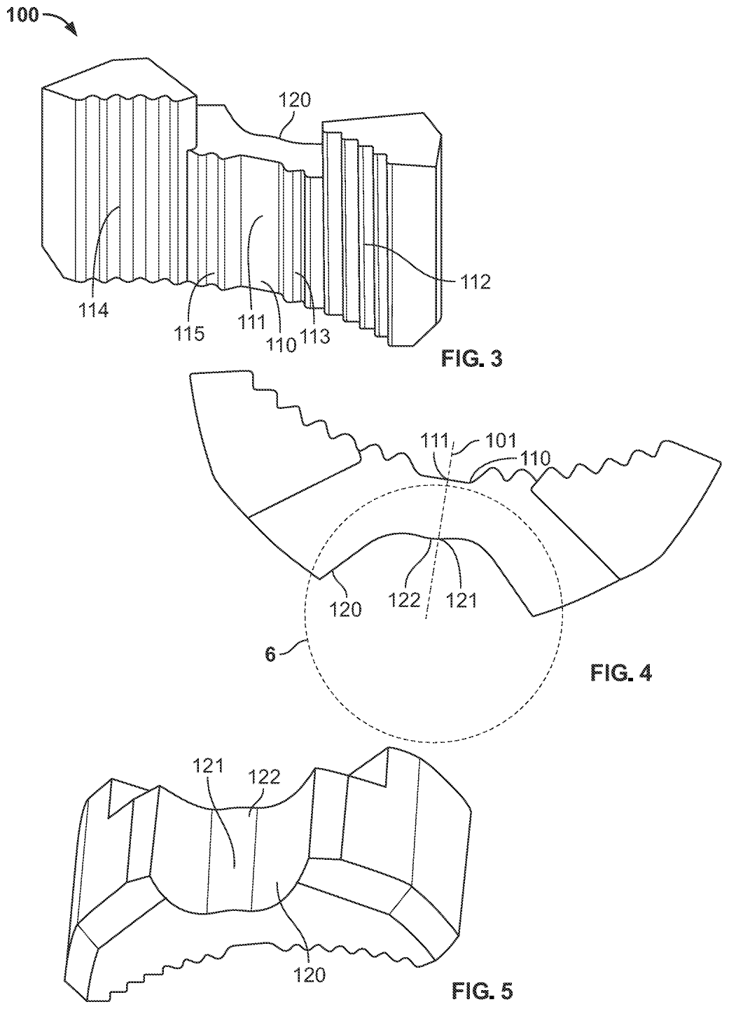

As shown in FIGS. 1 and 2, the pawl 100 includes a body 102 that has a rounded shape that conforms to a portion of the perimeter 53 of the ratchet gear 50. The pawl 100 also includes at least one or more extended portions 103 disposed on opposite sides of a recessed portion 104. In the illustrated embodiment shown in FIG. 2, the first ledge 63 of the switch 60 overlaps the recessed portion 104 of the pawl 100 between the extended portions 103 such that the switch 60 does not rest on, or interfere with, the pawl 100. Further, as shown in detail in FIGS. 3-6, the pawl 100 comprises a front surface 110 and the rear surface 120. The front surface 110 includes a front surface midpoint 111 and a first plurality of pawl teeth 112 disposed on a first side 113 of the front surface midpoint 111. The front surface 110 also includes a second plurality of pawl teeth 114 disposed on a second side 115 of the front surface midpoint 111. As shown in FIG. 2, the first plurality of pawl teeth 112 and the second plurality of pawl teeth 114 are operable to selectively engage the ratchet gear teeth 54 to limit rotation of the ratchet gear 50 in either a first rotational direction 203 (clockwise) or a second rotational direction 204 (counterclockwise) about the y-axis. As shown in FIGS. 4-6, the rear surface 120 also defines a rear surface midpoint 121 and an engagement surface 122 disposed in an engagement plane (not shown). The pawl 100 further includes a mid-plane 101 that intersects the front surface midpoint 111 and the rear surface midpoint 121. The biasing member 70 is operable to contact and engage with the engagement surface 122 of the pawl 100.

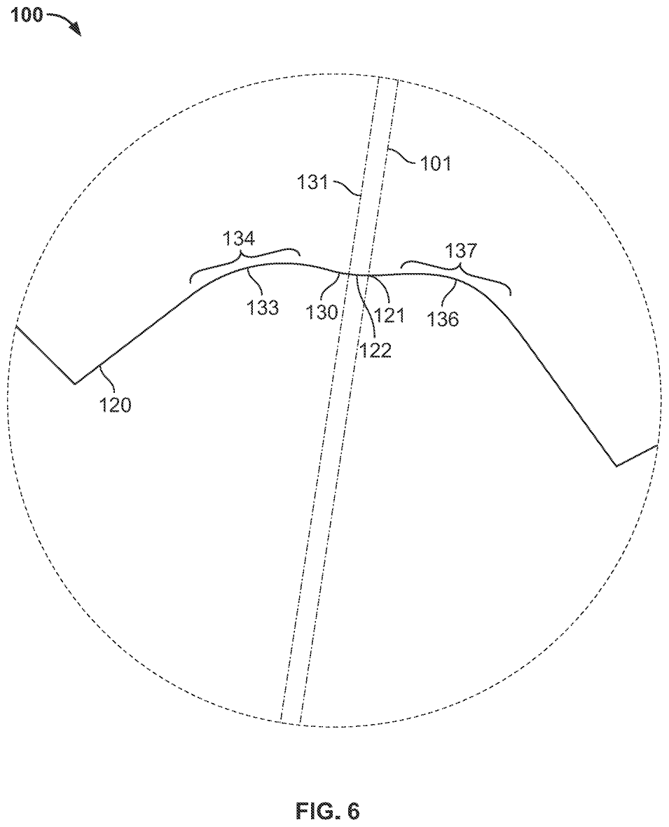

The shape of the rear surface 120 of the pawl 100 and the engagement between the rear surface 120 and the biasing member 70 is operable to generate a net force that biases the pawl 100 and the ratchet gear 50 away from the mid-plane 101 when the biasing member 70 contacts the rear surface 120 of the pawl 100 near the mid-plane 101. This ensures that the pawl 100 does not position itself in a central resting position where gear slippage or failure may occur, or where the pawl 100 and/or the ratchet gear 50 may undesirably or unintentionally move in either the first rotational direction or the second rotational direction. For example, in the illustrated embodiment shown in FIG. 6, the engagement surface 122 of the pawl 100 comprises a convex curve 130 formed between a first concave curve 133 and a second concave curve 136. Both the first concave curve 133 and the second concave curve 136 each define a parabola 134, 137 wherein the parabola 134 of the first concave curve 133 disposed in a first plane is more shallow than the parabola 137 of the second concave curve 136 disposed in a second plane. For example, the bottom of the parabola 134 of the first concave curve 133 defines a first depth relative to the convex curve 130. Similarly, the bottom of the parabola 137 of the second concave curve 136 defines a second depth relative to the convex curve 130. In the preferred embodiment, the first depth of the first concave curve 133 is smaller than the second depth of the second concave curve 136. In other words, the bottom of the parabola 137 of the second concave curve 136 is formed at a greater depth in the body of the pawl 100 than the bottom of the parabola 134 of the first concave curve 133. As shown in FIG. 6, the convex curve 130 is positioned off-center to the mid-plane 101 of the pawl 100 such that a convex curve mid-plane 131 and the mid-plane 101 of the pawl 100 are offset from one another. As such, the engagement surface 122, specifically, the convex curve 130, is non-perpendicular to the mid-plane 101 of the pawl 100 at the rear surface midpoint 121. In the illustrated embodiment, the engagement surface 122 is disposed at a selected angle with respect to the mid-plane 101 of the pawl 100. It is to be understood that the present disclosure contemplates the engagement surface 122 wherein the first depth of the first concave curve 133 is larger than the second depth of the second concave curve 136 such that the bottom of the parabola 134 of the first concave curve 133 is formed at a greater depth in the body of the pawl 100 than the bottom of the parabola 137 of the second concave curve 136. It is to be further understood, that the present disclosure is not limited to the exact curvature shown in the illustrated embodiments but contemplates any curvature sufficient to ensure that the engagement surface 122 at the mid-plane 101 is not perpendicular to the mid-plane 101.

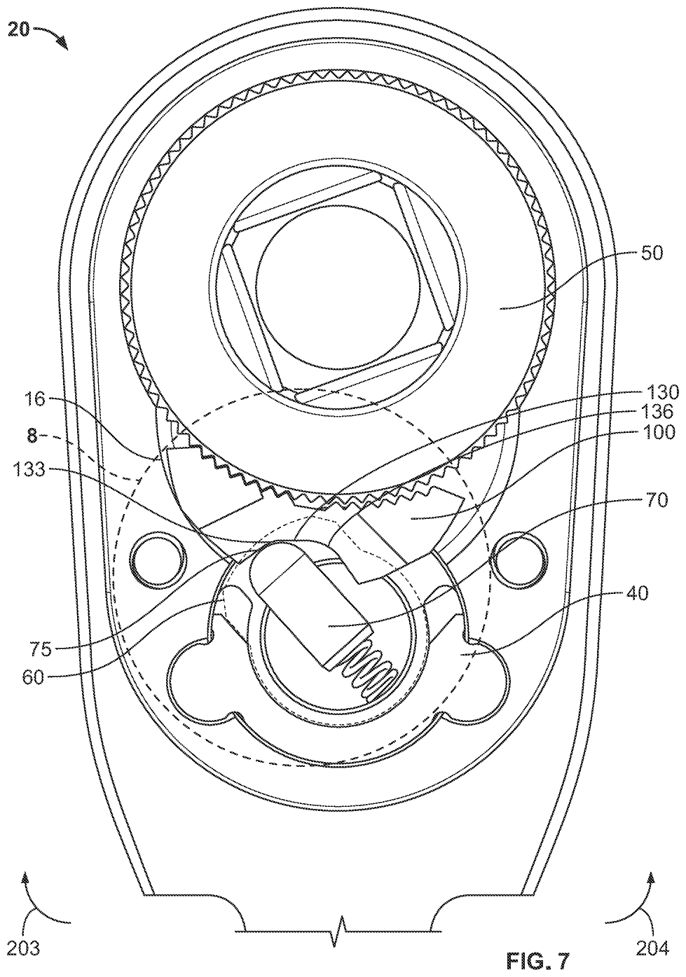

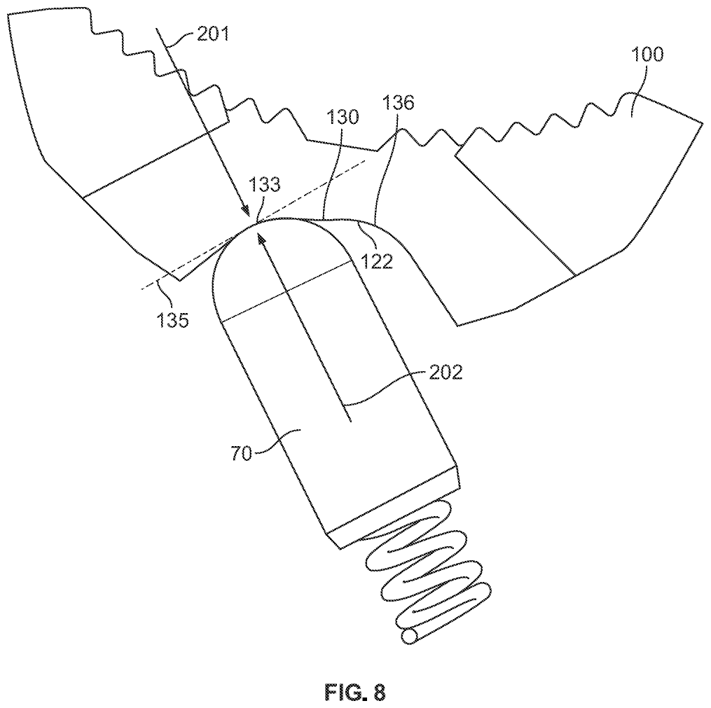

As shown in progression in FIGS. 7-12, the engagement surface 122 creates an instability between the biasing member 70 and the pawl 100 when the non-planar surface 75 of the biasing member 70 contacts the rear surface midpoint 121 at the mid-plane 101 of the pawl 100. When the instability is located at the mid-plane 101 of the pawl 100, a net force vector 200 resulting from the shape of the engagement surface 122 and a biasing force exerted by the biasing member 70 directs the pawl 100 away from the mid-plane 101. For example, in FIG. 7, the pawl 100 is wedged against the first sidewall 16 by the biasing member 70 and the ratchet gear 50 in the first rotational direction 203 when the lever 66 is activated and the switch 60 and the biasing member 70 are rotated counter-clockwise. This position of the pawl 100 relative to the ratchet gear 50, and specifically the engagement of the pawl teeth 112 with the gear teeth 54, limits rotation of the ratchet gear 50 in the clockwise direction, such that torque can be applied to a work piece (not shown) in a clockwise direction. In this position, as shown in FIG. 8, the net force between the biasing member 70 and the pawl 100 is zero where a biasing force vector 202 (created by the spring 76) opposes a resulting normal force vector 201 of the first concave curve 133. As shown, the resulting normal force vector 201 of the first concave curve 133 is perpendicular to a tangent 135 of the first concave curve 133. This net zero force between the biasing member 70 and the pawl 100 assists in keeping the pawl 100 and the ratchet gear 50 in a first position (clockwise position) shown in FIGS. 7 and 8.

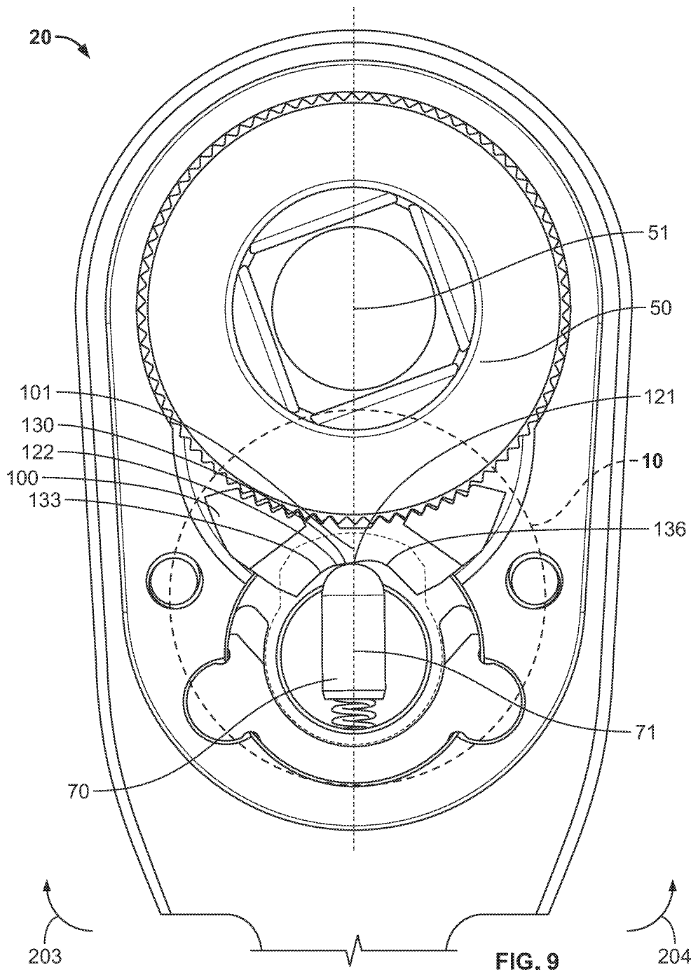

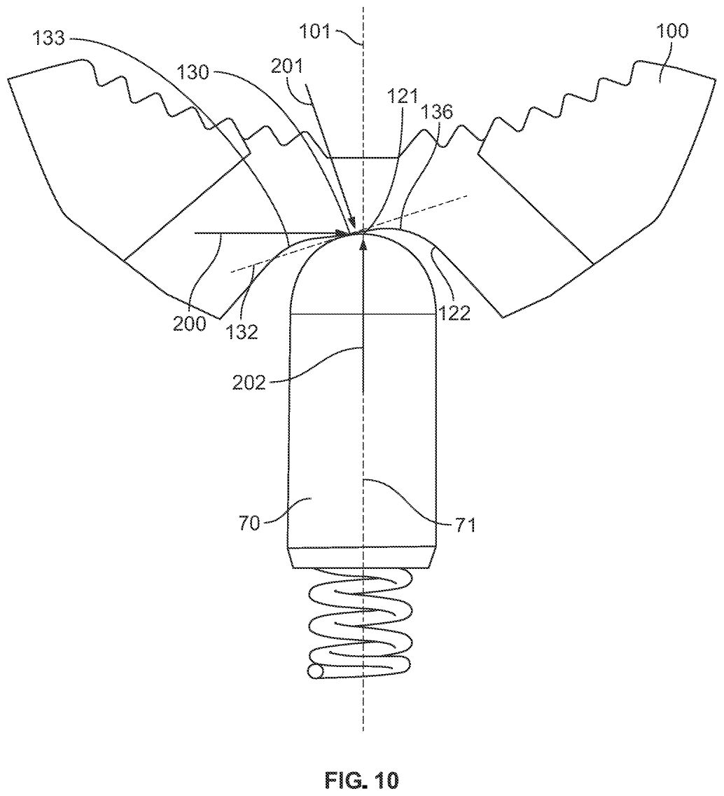

As shown in FIG. 9, when the pawl 100 and the ratchet gear 50 are moved in the second rotational direction 204 from activating the switch 60, the biasing member 70 moves across the engagement surface 122 of the pawl 100. When the biasing member 70 contacts, or is near to, the rear surface midpoint 121 at the mid-plane 101 of the pawl 100, the ratchet gear assembly 20 is in a temporary position. In this temporary position, a central axis 71 of the biasing member 70 is coincident with the mid-plane 101 of the pawl 100 and a mid-plane 51 of the ratchet gear 50. An instability is created between the biasing member 70 and the pawl 100 at the rear surface midpoint 121 because of the selected angle of the engagement surface 122 relative to the mid-plane 101 of the pawl 100. As shown in FIG. 10, a tangent 132 of the convex curve 130 forms a non-perpendicular angle relative to the mid-plane 101 of the pawl 100. A resulting normal force vector 201 of the convex curve 130 is perpendicular to the tangent 132 of the convex curve 130. Where the biasing member 70 contacts the rear surface midpoint 121 at the mid-plane 101 of the pawl 100, the resulting normal force vector 201 of the convex curve 130 is angled with respect to the biasing force vector 202 of the biasing member 70. Similarly, the central axis 71 of the biasing member 70, as well as the biasing force vector 202, form a non-perpendicular angle with the engagement surface 122 of the pawl 100. A non-zero sum of the biasing force vector 202 and the resulting normal force vector 201 of the convex curve 130 results in the net force vector 200 that forces the biasing member 70 and the pawl 100 away from the mid-plane 101.

It is to be understood that while the illustrated embodiment of FIGS. 9 and 10 depict the biasing member 70 directly in-line with the mid-plane 101 of the pawl 100, that the shape of the engagement surface 122 ensures there is an instability between the biasing member 70 and the pawl 100 across the entire convex curve 130. Put differently, the pawl 100 is biased towards the first position (clockwise) or the second position (counter-clockwise) whenever the pawl 100 is not seated in either the first position or the second position. As illustrated, whenever the biasing member 70 is positioned to the right of the pawl mid-plane 131, the pawl 100 is biased into the second position. Likewise, whenever the biasing member 70 is positioned to the left of the pawl mid-plane 131, the pawl 100 is biased into the first position.

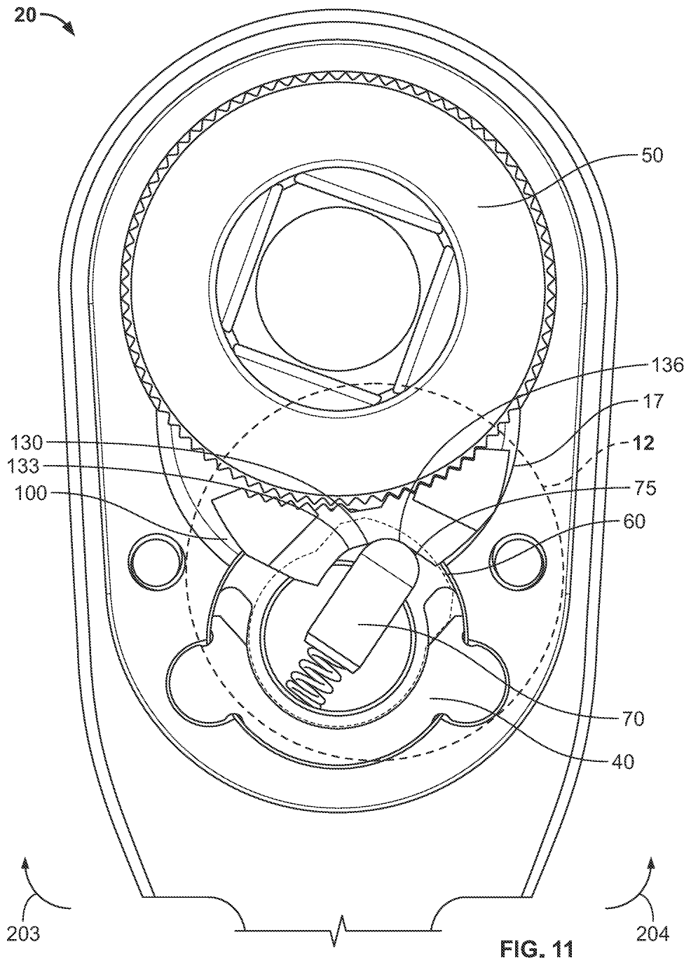

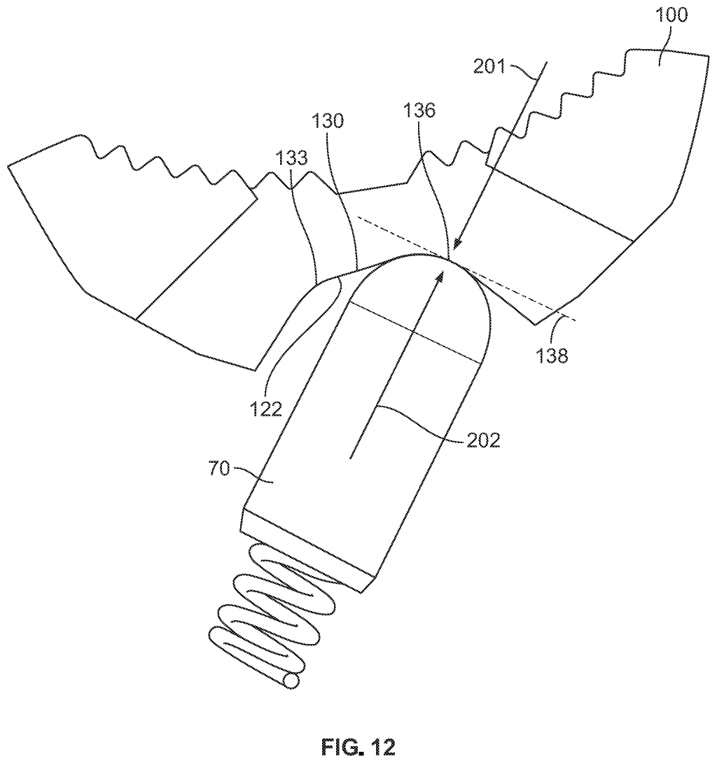

As shown in the illustrated embodiment of FIGS. 10 and 11, a net force vector 200 forces the biasing member 70 and the pawl 100 in the second rotational direction 204 to a second position (counter-clockwise position) where the pawl 100 is wedged against the second sidewall 17 by the biasing member 70 and the ratchet gear 50. As shown in FIG. 12, the net force between the biasing member 70 and the pawl 100 is zero where the biasing force vector 202 opposes the resulting normal force vector 201 of the second concave curve 136. The resulting normal force vector 201 of the second concave curve 136 is perpendicular to a tangent 138 of the second concave curve 136. This net zero force between the biasing member 70 and the pawl 100 assists in keeping the pawl 100 and the ratchet gear 50 in the second position (counter-clockwise position). This position of the pawl 100 relative to the ratchet gear 50, and specifically the engagement of the pawl teeth 112 with the gear teeth 54, limits rotation of the ratchet gear 50 in the counter-clockwise direction, such that torque can be applied to a work piece (not shown) in a counter-clockwise direction. Further, to move the pawl 100 and the ratchet gear 50 back to the first position (clockwise position) in the first rotational direction 203, the user may rotate the switch 60 via the lever 66 counter-clockwise with a sufficient force to overcome the net force vector 200 created at the mid-plane 101 of the pawl 100.

The present disclosure also contemplates an alternative convex curve embodiment where the engagement surface 122 is biased oppositely than shown in the illustrated embodiment. In such an embodiment (not shown) the engagement surface 122 includes a parabola 134 of the first concave curve 133 that is deeper than the parabola 137 of the second concave curve 136. As a result, the net force vector 200, at the mid-plane 101, biases the pawl 100 to the first rotational direction 203.

As described above, a biasing effect between the engagement surface 122 and the biasing member 70 is operable to bias (force) the pawl 100 and the ratchet gear 50 to either the first rotational direction 203 or the second rotational direction 204. In other words, the configurations disclosed herein ensure that the net force between the biasing member 70 and the pawl 100 and the ratchet gear 50 is not zero when the biasing member 70 contacts the rear surface midpoint 121 at the mid-plane of the pawl 101, and at any point along the engagement surface 122 when the pawl 100 is not positioned in either the first position or the second position. In use, the biasing effect continually biases the pawl 100 and the ratchet gear 50 towards the first sidewall 16 or the second sidewall 17 in the first rotational direction 203 or the second rotational direction 204, respectively. By preventing the pawl 100 from positioning itself in the central resting position, the present disclosure provides for a more reliable ratchet tool 1.

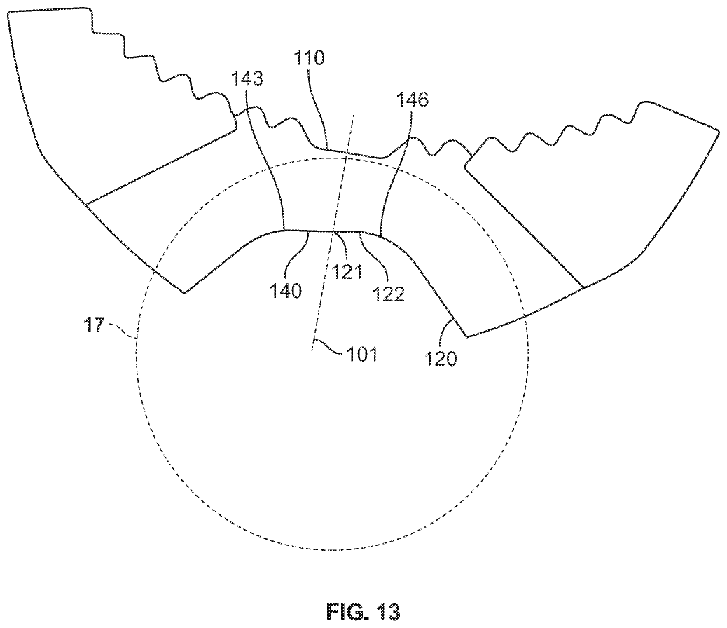

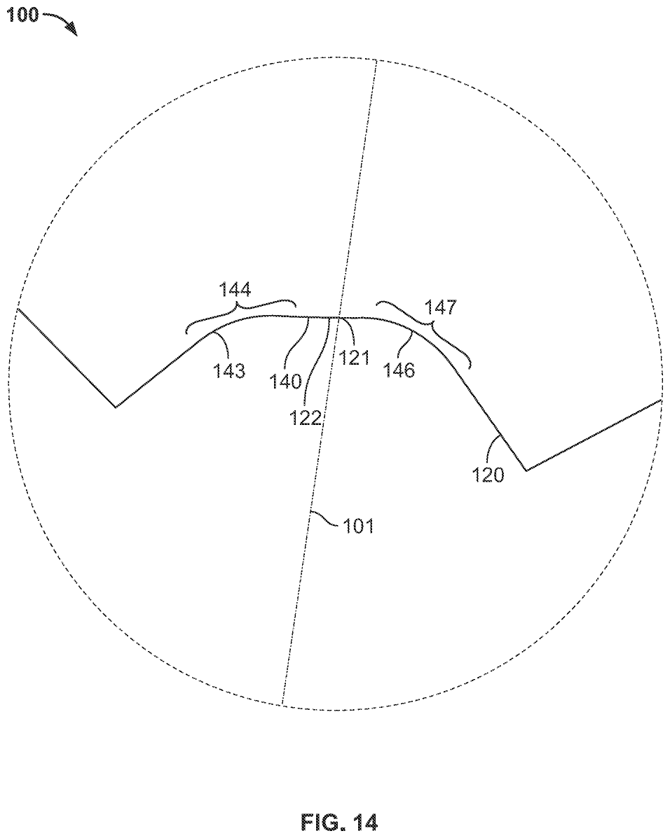

The present disclosure also contemplates different geometries for the rear surface 120 of the pawl 100 that likewise create an instability between the biasing member 70 and the rear surface 120 of the pawl 100 at the rear surface midpoint 121, i.e., the biasing effect. FIG. 13 illustrates a configuration for the rear surface 120 of the pawl 100 wherein the engagement surface 122 is sloped. This alternative configuration also creates a biasing effect between the biasing member 70 and the rear surface 120 of the pawl 100 at the rear surface midpoint 121. As shown in FIGS. 13 and 14, the sloped engagement surface 122 includes a planar surface 140 disposed in an engagement plane between a first concave curve 143 and a second concave curve 146. Both the first concave curve 143 and the second concave curve 146 each define a parabola 144, 147 wherein the parabola 144 of the first concave curve 143 disposed in a first plane is more shallow than the parabola 147 of the second concave curve 146 disposed in a second plane. Because the parabola 144 of the first concave curve 143 is more shallow than the parabola 147 of the second concave curve 146, the planar surface 140 is sloped at the rear surface midpoint 121 at the mid-plane of the pawl 101. For example, the bottom of the parabola 144 of the first concave curve 143 defines a first depth relative to planar surface 140. Similarly, the bottom of the parabola 147 of the second concave curve 146 defines a second depth relative to planar surface 140. In the preferred embodiment, the first depth of the first concave curve 143 is smaller than the second depth of the second concave curve 146. In other words, the bottom of the parabola 147 of the second concave curve 146 is formed at a greater depth in the body of the pawl 100 than the bottom of the parabola 144 of the first concave curve 143. It is to be understood that the present disclosure contemplates slopes of varying degrees for the sloped engagement surface 122 of the pawl 100 such that the sloped engagement surface 122 is disposed at a selected angle with respect to the mid-plane 101 of the pawl 100.

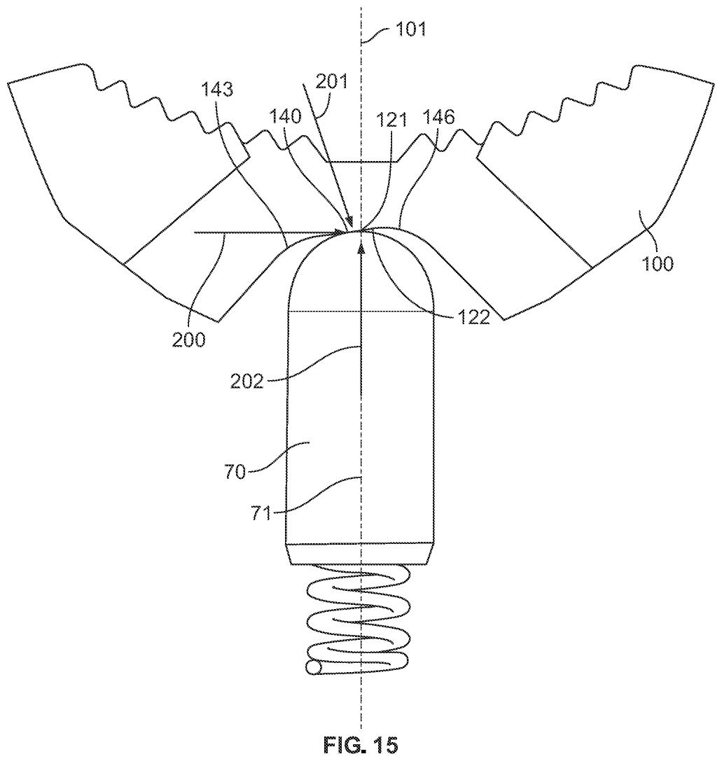

As shown in FIG. 15, the planar surface 140 forms a non-perpendicular angle relative to the mid-plane 101 of the pawl 100 at the rear surface midpoint 121. A resulting normal force vector 201 of the planar surface 140 is perpendicular to the planar surface 140. Where the biasing member 70 contacts the rear surface midpoint 121 at the mid-plane 101 of the pawl 100, the resulting normal force vector 201 of the planar surface 140 is angled with respect to the biasing force vector 202 of the biasing member 70. In the temporary position, the central axis 71 of the biasing member 71 is coincident with the mid-plane 101 of the pawl 100 and a mid-plane 51 of the ratchet gear 50. As shown, the central axis 71 of the biasing member 70, as well as the biasing force vector 202, form a non-perpendicular angle with the engagement surface 122 of the pawl 100. A non-zero sum of the biasing force vector 202 and the resulting normal force vector 201 of the planar surface 140 results in the net force vector 200 that forces the biasing member 70 and the pawl 100 away from the mid-plane 101. As illustrated, the net force vector 200 biases the pawl 100 toward the second position. As such, the instability between the planar surface 140 and the biasing member 70 is operable to force the pawl 100 and the ratchet gear 50 to either the first rotational direction 203 or the second rotational direction 204. It is to be understood that the present disclosure contemplates a sloped engagement surface 122 that is the mirror image of the sloped engagement surface 122 shown in the figures. It is also understood that the sloped engagement surface 122 could be mirrored (not shown) such that the pawl 100 is generally biased into the first position.

The present described disclosure is described in such full, clear, concise, and exact terms as to enable any person skilled in the art to which it pertains to practice the same. It is to be understood that the foregoing described preferred aspects of the disclosure and that modification may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed is:

1. A ratchet tool comprising:
a ratchet head, the ratchet head comprising:
a ratchet assembly cavity;
a ratchet gear rotatably disposed in the ratchet assembly cavity, wherein the ratchet gear includes a drive member for transmitting torque to a work piece, and wherein the ratchet gear defines a perimeter and a plurality of ratchet gear teeth disposed about the perimeter;
a pawl operable to selectively engage with the ratchet gear, the pawl comprising:
a front surface defining a front surface midpoint including a first plurality of pawl teeth disposed on a first side of the front surface midpoint and selectively engageable with the ratchet gear teeth and a second plurality of pawl teeth disposed on a second side of the front surface midpoint and selectively engageable with the ratchet gear teeth, the pawl being operable to selectively engage either of the first and second pluralities of pawl teeth with the ratchet gear teeth to limit rotation of the ratchet gear in one of a first rotational direction or a second rotational direction, and
a rear surface defining a rear surface midpoint, the pawl defining a mid-plane intersecting the front surface midpoint and the rear surface midpoint, the rear surface further defining an engagement surface disposed in an engagement plane, the engagement plane disposed at a selected angle with respect to the mid-plane; and
a switch disposed through a switch aperture in the ratchet assembly cavity, wherein the switch includes a biasing member operable to engage the rear surface of the pawl such that the biasing member pushes the pawl against the ratchet gear.

2. The ratchet tool of claim 1, wherein the selected angle of the engagement surface is non-perpendicular.

3. The ratchet tool of claim 2, wherein the engagement surface is sloped relative to the mid-plane of the pawl.

4. The ratchet tool of claim 3, wherein the engagement surface creates an instability between the biasing member and the pawl at the mid-plane of the pawl and a mid-plane of the ratchet gear such that the pawl is forced in either the first rotational direction or the second rotational direction.

5. The ratchet tool of claim 1, wherein the engagement surface of the pawl further comprises:
a first concave curve;
a second concave curve; and
a convex curve formed between the first concave curve and the second concave curve.

6. The ratchet tool of claim 5, wherein the convex curve is positioned off-center to the mid-plane of the pawl and a tangent of the convex curve forms a non-perpendicular angle relative to the mid-plane of the pawl.

7. The ratchet tool of claim 6, wherein the convex curve creates an instability between the biasing member and the pawl at the mid-plane of the pawl and a mid-plane of the ratchet gear such that the pawl is forced in either the first rotational direction or the second rotational direction.

8. The ratchet tool of claim 1, wherein the biasing member comprises a spring and a pin, the spring and pin being at least partially disposed within the switch.

9. The ratchet tool of claim 8, wherein the pin further comprises a body and a head, the head including a non-planar surface.

10. A ratchet tool comprising:
a ratchet head, the ratchet head comprising:
a ratchet assembly cavity;
a ratchet gear rotatably disposed in the ratchet assembly cavity, wherein the ratchet gear includes a drive member for transmitting torque to a work piece, and wherein the ratchet gear defines a perimeter and a plurality of ratchet gear teeth disposed about the perimeter;
a pawl operable to selectively engage with the ratchet gear, the pawl comprising:
a front surface defining a front surface midpoint including a first plurality of pawl teeth disposed on a first side of the front surface midpoint and selectively engageable with the ratchet gear teeth and a second plurality of pawl teeth disposed on a second side of the front surface midpoint and selectively engageable with the ratchet gear teeth, the pawl being operable to selectively engage either of the first and second pluralities of pawl teeth with the ratchet gear teeth to limit rotation of the ratchet gear in one of a first rotational direction or a second rotational direction, and
a rear surface defining a rear surface midpoint, the pawl defining a mid-plane intersecting the front surface midpoint and the rear surface midpoint, the rear surface further defining an engagement surface disposed in an engagement plane;
a switch disposed through a switch aperture in the ratchet assembly cavity; and
a biasing member partially disposed within the switch and operable to engage the engagement surface of the pawl such that the biasing member pushes the pawl against the ratchet gear,
wherein a central axis of the biasing member and the engagement surface of the pawl form a non-perpendicular angle when the biasing member contacts the engagement surface of the pawl.

11. The ratchet tool of claim 10, wherein the engagement surface is sloped relative to the mid-plane of the pawl.

12. The ratchet tool of claim 11, wherein the engagement surface creates an instability between the biasing member and the pawl at the mid-plane of the pawl and a mid-plane of the ratchet gear such that the pawl is forced in either the first rotational direction or the second rotational direction.

13. The ratchet tool of claim 10, wherein the engagement surface of the pawl further comprises:
a first concave curve;
a second concave curve; and
a convex curve formed between the first concave curve and the second concave curve.

14. The ratchet tool of claim 13, wherein the convex curve is positioned off-center to the mid-plane of the pawl and a tangent of the convex curve forms a non-perpendicular angle relative to the mid-plane of the pawl.

15. The ratchet tool of claim 14, wherein the convex curve creates an instability between the biasing member and the pawl at the mid-plane of the pawl and a mid-plane of the ratchet gear such that the pawl is forced in either the first rotational direction or the second rotational direction.

16. A pawl for a ratchet tool comprising:
a front surface defining a front surface midpoint including a first plurality of pawl teeth disposed on a first side of the front surface midpoint and selectively engageable with a plurality of ratchet gear teeth and a second plurality of pawl teeth disposed on a second side of the front surface midpoint and selectively engageable with the ratchet gear teeth, the pawl being operable to selectively engage either of the first and second pluralities of pawl teeth with the ratchet gear teeth; and
a rear surface defining a rear surface midpoint, the pawl defining a mid-plane intersecting the front surface midpoint and the rear surface midpoint, the rear surface further defining an engagement surface disposed in an engagement plane, the engagement plane disposed at a selected angle with respect to the mid-plane,
wherein the engagement surface creates an instability between a biasing member and the pawl when the biasing member contacts the pawl at the mid-plane of the pawl such that the pawl is forced in either a first rotational direction or a second rotational direction.

17. The pawl of claim 16, wherein the selected angle of the engagement surface is non-perpendicular.

18. The pawl of claim 17, wherein the engagement surface is sloped relative to the mid-plane of the pawl.

19. The pawl for claim 16, wherein the engagement surface of the pawl further comprises:
a first concave curve;
a second concave curve; and
a convex curve formed between the first concave curve and the second concave curve.

20. The pawl of claim 19, wherein the convex curve is positioned off-center to the mid-plane of the pawl and a tangent of the convex curve forms a non-perpendicular angle relative to the mid-plane of the pawl.
